(19) United States
(12) Patent Application Publication
(10) Pub. No.: US 2025/0315975 A1
(43) Pub. Date: Oct. 9, 2025

(54) METHOD AND DEVICE FOR TRAINING A MACHINE LEARNING MODEL FOR PROCESSING MULTIMODAL DATA

(71) Applicant: Robert Bosch GmbH, Stuttgart (DE)

(72) Inventors: Andre Wagner, Hannover (DE); Annika Hagemann, Hildesheim (DE); Jan Fabian Schmid, Hamburg (DE)

(21) Appl. No.: 19/169,361

(22) Filed: Apr. 3, 2025

(30) Foreign Application Priority Data
Apr. 5, 2024 (DE) 10 2024 203 137.2

(51) Int. Cl. G06T 7/73; G06N 20/00

(52) U.S. Cl. CPC G06T 7/73; G06N 20/00; G06T 2207/10028; G06T 2207/20081; G06T 2207/20084; G06T 2207/30252

(57) ABSTRACT

A method for training a machine learning model for processing multimodal data. The machine learning model includes a first and a second encoder, a transformer, a first pose regressor head, and a second pose regressor head. The method includes: merging the features of the first and of the second sensor data into a common feature embedding space by the transformer; decoding the merged features from the common feature embedding space for outputting a pose estimate for the first sensor by the first pose regressor head; decoding the merged features from the common feature embedding space for outputting a pose estimate for the second sensor by the second pose regressor head; minimizing a loss function for optimizing the pose estimation for the first and the second sensor; and providing the trained machine learning model for processing multimodal data.

### FIELD

The present invention relates to a method and a device for training a machine learning model for processing multimodal (sensor) data.

### BACKGROUND INFORMATION

Image-data-based and/or other sensor-data-based pre-training methods such as DINO and Masked Image Modeling play a central role in the development of advanced visual processing systems. These methods have made possible advances in the generation of features that are useful for a multitude of applications, from image recognition to image segmentation. However, despite their successes, they reach their limits when it comes to generating features with a deep geographical understanding. This is particularly relevant in areas where precise understanding of spatial relationships and properties is critical, such as in the case of autonomous vehicles and/or remote sensing. In particular in light of the increasing complexity and variety of the sensors in systems such as autonomous vehicles that comprise cameras, radar, LiDAR, IMU, GNSS, and more, the ability to use precisely aligned sensor data and to develop models from them that have a deep understanding of the physical world is becoming more and more important.

Most modern pre-training methods are based on crossmodal masked autoencoders and contrastive learning in order to build a bridge between the different modalities. Such methods aim to develop models that can effectively work with data from various modalities (e.g., text, images, audio data), and are relevant to tasks where understanding and integration of information from multiple sources is critical. Different approaches are used to learn representations of the data.

Crossmodal masked autoencoders are an extension of the autoencoder concept in which input data are partially masked (i.e., certain portions are intentionally hidden) and then reconstructed by the model. In a crossmodal context, data from various modalities are processed together. For example, such a model may obtain radar data of a radar sensor and may obtain image data of a camera that were acquired at the same time, wherein portions of the radar data or of the image data are masked. The aim is to reconstruct the masked portions correctly by using the information from the other modality.

Contrastive learning is an approach aimed at positioning similar (or positive) data points closer together and dissimilar (or negative) data points further apart from one another in an embedded space. When used in a crossmodal context, pairs or groups of data points from various modalities are used to train the model to recognize the correspondences between the modalities. For example, such a model may learn to pair radar data and image data by learning which radar data and image data belong together (similar) and which do not (dissimilar).

Although these methods constitute progress, they lack a deep geometrical understanding, which is critical for many applications. The challenge of generating geometry-aware features thus remains unresolved. This is because, as described above in detail, the previous methods focus on inpainting (reconstruction or restoration) of masked signals and neglect the model-driven information about spatial alignments, rotations, and orientations, which, however, are indispensable for a deep geometrical understanding.

It is an object of the present invention to specify an improved method and/or a device for training a machine learning model for processing multimodal (sensor) data.

The object may be achieved by a method having certain features of the present invention. The object is achieved by a device having certain features of the present invention.

### SUMMARY

According to a first aspect of the present invention, a method for training a machine learning model for processing multimodal sensor data is provided, the machine learning model comprising a first and a second encoder, a transformer, a first pose regressor head, and a second pose regressor head. According to an example embodiment of the present invention, the method comprising the steps of:
providing first sensor data acquired by a first sensor and second sensor data acquired by a second sensor;
compressing the first sensor data by the first encoder into a feature dimension with features from the first sensor data;
compressing the second sensor data by the second encoder into a feature dimension with features from the second sensor data;
merging the features of the first and of the second sensor data into a common feature embedding space by the transformer;
decoding the merged features from the common feature embedding space for outputting a pose estimate for the first sensor by the first pose regressor head;
decoding the merged features from the common feature embedding space for outputting a pose estimate for the second sensor by the second pose regressor head;
minimizing a loss function for optimizing the pose estimation for the first and the second sensor; and
providing the trained machine learning model for processing multimodal sensor data.

It is understood that the steps according to the present invention and further optional steps do not necessarily have to be performed in the order shown, but can also be performed in a different order. Further intermediate steps may also be provided. The individual steps may also comprise one or more substeps without departing from the scope of the method according to the present invention.

According to a second aspect of the present invention, a device for training a machine learning model for processing multimodal data is provided, the machine learning model comprising a first and a second encoder, a transformer, a first pose regressor head, and a second pose regressor head. According to an example embodiment of the present invention, the device comprising an evaluation and computing unit designed to perform the following steps:
providing first sensor data acquired by a first sensor and second sensor data acquired by a second sensor;
compressing the first sensor data by the first encoder into a feature dimension with features from the first sensor data;
compressing the second sensor data by the second encoder into a feature dimension with features from the second sensor data;
merging the features of the first and of the second sensor data into a common feature embedding space by the transformer;
decoding the merged features from the common feature embedding space for outputting a pose estimate for the first sensor by the first pose regressor head;
decoding the merged features from the common feature embedding space for outputting a pose estimate for the second sensor by the second pose regressor head;
minimizing a loss function for optimizing the pose estimation for the first and the second sensor; and
providing the trained machine learning model for processing multimodal data.

The statements made for the method of the present invention apply analogously to the system of the present invention. It is understood that linguistic modifications of features formulated for the method of the present invention can be reformulated for the system in accordance with standard linguistic practice, without such formulations having to be explicitly listed here.

Using the sensor position for the pre-training, which constitutes a promising direction that is still unexplored, could play a key role in the development of pre-training methods that are not only crossmodal but also have a profound geometrical awareness.

Unlike related-art methods, the present method does not require any technically complicated approaches, such as masked image modeling, and can therefore be designed to be technically simpler and less complex. The processing of multimodal data, i.e., of data originating from sensor sources of various sensor types, can be optimized by the present method since the training of the machine learning model that is trained for multimodal data processing is improved.

The basic concept of the method of the present invention is in particular to use a single real entity connecting all sensors to a single information source that is available across all sensor modalities. In the present case, this entity is the sensor pose. As reliable as possible an estimation of the pose directly from the features encoded by the sensors requires a deep geometrical and physical understanding. A semantic understanding of the world is also needed. This geometrical, physical, and semantic understanding can be taught to the machine learning model in the present case. Only the real pose is needed as common information between the sensors in order to scale large data sets for the pre-training. The real pose information can be provided in a simple way.

In the present case, each modality, i.e., each sensor, preferably has its own encoder, which compresses the raw information of the corresponding sensor measurement into a feature dimension. In particular, transformer-based encoders can be suitable since they can be easily adapted to different modalities. From the features of each modality, a further transformer then combines the information into a common feature embedding space. From this common embedding space, preferably n copies (in particular one copy for each sensor) of a pose regressor head then decode this information and estimate a pose of the corresponding sensor with respect to a global coordinate system or relatively between two sensors.

The method is used to improve the quality of feature extraction across multiple sensor modalities. In particular, the solving of problems in the area of geometric regression can be optimized. The method is preferably designed as a pre-training method for later use in multiple state estimations or perception backbones. However, the present method or a machine learning model trained according to the method can also be used directly as a pose estimation method.

The method or the machine learning model trained according to the method of the present invention can be used for multimodal foundation models or SLAM systems. The method or the machine learning model trained according to the method can also be used in the area of parking assistance systems.

In the present case, according to an example embodiment of the present invention, the machine learning model comprises two encoders, in particular one for each sensor data source. Each encoder is preferably specialized in compressing the data of the corresponding sensor and converting them into a feature dimension. This makes it possible to process different types of sensor data efficiently and specifically. After the initial processing by the encoders, the features from both sensor data sources are merged into a common feature embedding space by a transformer. This step makes it possible for the model to recognize and use relationships and dependences between the features of the different sensors. The model has multiple separate pose regressor heads (corresponding to the number of sensors), one for each sensor. Pose regressor heads in a machine learning model are specialized network components designed to estimate the pose of an object or of an entity from the processed features. A “pose” refers to the spatial arrangement or orientation of a sensor or of another object in space and can be defined by parameters such as position, alignment, and, where applicable, scaling. The precise estimation of poses is important for tasks such as object recognition, motion tracking, and interaction between physical and virtual objects. This configuration allows the model to estimate individual poses for each sensor based on the combined features in the common embedding space. By minimizing a loss function, the accuracy of the pose estimations for both sensors is improved. These optimization steps are for fine-tuning the model in order to make precise predictions possible. After the training, the model is configured to process multimodal sensor data. It can be used for practical applications requiring precise estimation of poses from data of different sensors.

Data sets that consist of data from multiple sensors, such as B. nuScenes, can be used as training data. Further data sets can also be used.

In a further aspect of the present invention, the first encoder is assigned to the first sensor and comprises a transformer-based encoder or a vision encoder or a radar encoder or a lidar encoder. Alternatively or additionally (i.e., “and/or”), the second encoder is assigned to the second sensor and comprises a transformer-based encoder or a vision encoder or a radar encoder or a lidar encoder.

Encoders transform raw input data into a higher-level, compact feature representation (feature embedding), which is used for further processing steps within the model. Each of these encoder types uses specific architectures and technologies that are tailored to the properties of the corresponding data. A transformer-based encoder is based on the transformer architecture originally designed for processing sequence-to-sequence tasks in natural language processing (NLP). This architecture uses mechanisms such as self-attention and positional encoding in order to detect relationships between the elements in the input data regardless of their distance within the sequence. In a transformer-based encoder, the input data are converted into a set of feature vectors, which can then be used for tasks such as classification, regression, or other specific analyses. A vision encoder is designed for processing image data or visual information. It generally uses convolutional neural networks (CNNs) or newer architectures such as vision transformers (ViTs) to transform the raw pixel values of an image into a compact, informative feature representation. This representation encompasses important visual features such as edges, textures, shapes, and object relationships in the image. Vision encoders are fundamental to computer vision tasks, such as object recognition, image segmentation, and image classification. A radar encoder or lidar encoder is specialized in the processing of radar data, which are usually in the form of signals or point clouds and provide information about the distance, velocity, and angular position of objects relative to the radar sensor. These encoders can be based on technologies such as deep learning, specifically on adapted CNNs, or on networks optimized for point clouds, such as PointNet. They aim to convert the raw radar signals into a feature representation that can be used for object recognition and tracking, collision avoidance, and other radar-based applications.

In a further aspect of the present invention, the pose estimation for the first sensor and the pose estimation for the second sensor are carried out with respect to a global coordinate system or in relative terms between the sensors.

The “pose estimation with respect to a global coordinate system” means that the position and orientation (pose) of an entity, i.e., of each sensor, is estimated in relation to a defined common coordinate system. A global coordinate system provides a uniform reference frame against which all measurements and estimations are calibrated. This makes consistent interpretation of the pose data across sensors possible, regardless of their individual position or alignment. The “relative pose estimation between the sensors” refers to determining the position and orientation of one entity to another, without the need for a global reference frame. This method considers the spatial relationships between the sensors and the observed object and can be useful for recognizing and interpreting changes or movements of the object relative to the sensors.

In a further aspect of the present invention, minimizing the loss function for optimizing the pose estimation for the first and the second sensor comprises comparing with a ground-truth value of a real pose of the first sensor and of the second sensor.

According to an example embodiment of the present invention, minimizing the loss function is a step aimed at improving the accuracy of the pose estimations performed by the model. This is done by comparing the poses predicted by the model with the actual, real poses of the objects as detected by the two sensors. The real poses serve as ground-truth values (ground truths). A loss function quantifies the difference or error between the predicted poses of the model and the actual, real poses of the objects. The aim is to minimize this error. The optimization of the loss function is carried out by adjusting the internal (hyper) parameters of the machine model (e.g., weights in a neural network) in order to improve the accuracy of the pose estimations. Ground-truth values represent the true, real poses of the objects as detected by the sensors. They are used as a reference in order to evaluate the accuracy of the estimations of the model. The comparison comprises the pose estimates of the first and the second sensor, which means that the model is to learn to estimate accurate poses for the sensors. This optimization method makes it possible for the model to recognize and account for differences in the data or the performance between the two sensors, resulting in an improved overall performance of the system.

In a further aspect of the present invention, the pose estimation for the first and/or the second sensor comprises a rotation estimation and a translation estimation. The rotation estimation comprises solving a regression-by-classification problem.

In the present case, according to an example embodiment of the present invention the pose estimation is thus preferably divided into a rotation estimation and a translation estimation.

In a further aspect of the present invention, solving the regression-by-classification problem comprises dividing a rotation space into a voxel grid and classifying which voxel optimally represents a rotation; and regressing an actual rotation as an offset from a voxel center to the rotation estimate.

According to an example embodiment of the present invention, the rotation estimation is preferably carried out on a specific orthogonal group so that the problem of the rotation estimation can be formulated as a two-stage problem. The rotation estimation is formulated as a regression-by-classification problem, i.e., the entire space of the 3D rotations is divided into a voxel grid. Then, the classification as to which voxel optimally represents the rotation is carried out. Subsequently, the actual rotation is regressed as an offset from the voxel center to the actual fine-grained rotation estimate. Since it may not be possible to define an unambiguous world coordinate system, the problem can be considered as a problem of relative pose estimation between pairs of sensors. A global coordinate system can then again be created by coordinate transformation and defined in a unified manner for the sensors. The RelPose++ (arxiv.org/abs/2305.04926) approach can be used for the translation estimation used here.

In a further aspect of the present invention, the first sensor comprises a lidar sensor and/or a radar sensor and/or an ultrasonic sensor and/or a camera sensor and/or an infrared sensor and/or an acceleration sensor and/or a global navigation satellite system (GNSS) sensor. Alternatively or additionally, the second sensor comprises a lidar sensor and/or a radar sensor and/or an ultrasonic sensor and/or a camera sensor and/or an infrared sensor and/or an acceleration sensor and/or a global navigation satellite system (GNSS) sensor.

It is understood that other sensor types are possible and that the list given is not to be understood in a limiting manner.

In a further aspect of the present invention, the first and the second sensor are arranged at different positions of a vehicle in order to detect the vehicle and/or a vehicle environment.

Of course, it is understood that the vehicle may also comprise more than two, in particular different, sensors. The first and the second sensor may alternatively also be arranged at different positions of a robot or of a medical device or of an industrial machine and/or of a quality control system and/or of a safety monitoring system.

A further aspect of the present invention provides a computer program comprising program code in order to perform at least parts of the method according to the present invention in one of its embodiments when the computer program is executed on a computer. In other words, according to the present invention, a computer program (product) comprising commands that, when the program is executed by a computer, prompt the computer to perform the method/the steps of the method according to the present invention in one of its embodiments.

In a further aspect of the present invention, a computer-readable data carrier comprising program code of a computer program is proposed in order to perform at least parts of the method according to the present invention in one of its embodiments when the computer program is executed on a computer. In other words, the present invention relates to a computer-readable (storage) medium comprising commands that, when executed by a computer, cause the computer to perform the method/the steps of the method according to the present invention in one of its embodiments.

The described embodiments and developments of the present invention can be combined with one another as desired.

Further possible embodiments, developments, and implementations of the present invention also include not explicitly mentioned combinations of features of the present invention described above or below with respect to exemplary embodiments.

### BRIEF DESCRIPTION OF THE DRAWINGS

The figures are intended to provide a better understanding of the embodiments of the present invention. They illustrate example embodiments and, in connection with the description, serve to explain principles and concepts of the present invention.

Other embodiments and many of the mentioned advantages emerge with reference to the figures. The shown elements of the figures are not necessarily drawn to scale with respect to one another.

### BRIEF DESCRIPTION OF THE DRAWINGS

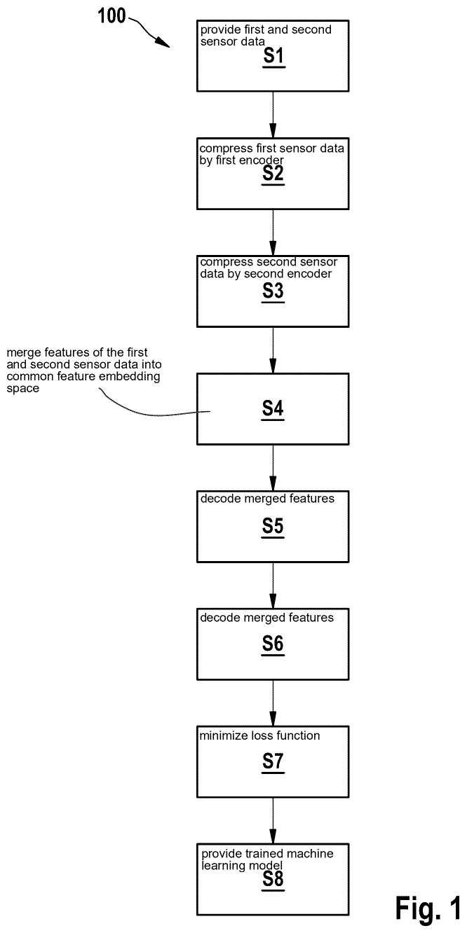

FIG. 1 shows a schematic flow chart of an exemplary embodiment of a method of the present invention.

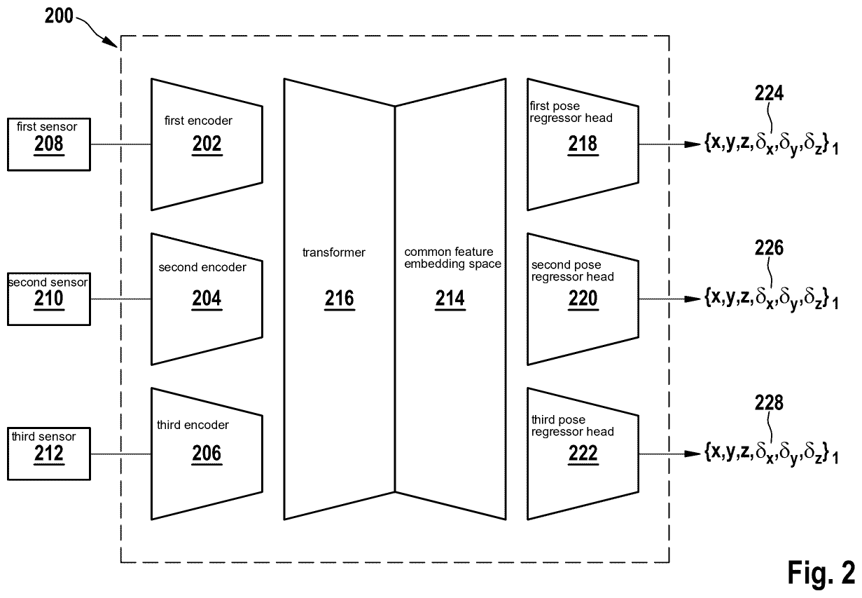

FIG. 2 shows a schematic block diagram of an exemplary embodiment of a device of the present invention.

### DETAILED DESCRIPTION OF EXAMPLE EMBODIMENTS

In the figures of the drawings, identical reference signs refer to identical or functionally identical elements, parts, or components unless stated otherwise.

FIG. 1 shows a schematic flow chart of a method for training a machine learning model for processing multimodal sensor data.

In any embodiment, the method can be performed at least partially by a device 100 that can comprise, for this purpose, multiple components (not shown in detail), for example one or more provisioning units and/or at least one evaluation and computing unit. It is understood that the provisioning unit may be designed together with the evaluation and computing device or may be different therefrom. Furthermore, the device 100 may comprise a memory unit and/or an output unit and/or a display unit and/or an input unit.

The computer-implemented method comprises at least the following steps:
In a step S1, first sensor data acquired by a first sensor and second sensor data acquired by a second sensor are provided.
In a step S2, the first sensor data are compressed by the first encoder into a feature dimension with features from the first sensor data.
In a step S3, the second sensor data are compressed by the second encoder into a feature dimension with features from the second sensor data.
In a step S4, the features of the first and of the second sensor data are merged into a common feature embedding space by the transformer.
In a step S5, the merged features from the common feature embedding space are decoded for outputting a pose estimate for the first sensor by the first pose regressor head.
In a step S6, the merged features from the common feature embedding space are decoded for outputting a pose estimate for the second sensor by the second pose regressor head.
In a step S7, a loss function for optimizing the pose estimation for the first and the second sensor is minimized. Minimizing the loss function for optimizing the pose estimation for the first and the second sensor comprises comparing with a ground-truth value of a real pose of the first sensor and of the second sensor.
In a step S8, the trained machine learning model is provided for processing multimodal sensor data.

FIG. 2 shows a block diagram of an exemplary embodiment of the present method or the device. In particular, the schematic structure of the machine learning model 200 is shown.

The machine learning model 200 comprises, by way of example, a first encoder 202, a second encoder 204, and a third encoder 206. Naturally, the machine learning model 200 may also comprise only two encoders or more than three encoders.

The first encoder 202 is assigned to a first sensor 208. The first sensor 208 is a camera sensor. The second encoder 202 is assigned to a second sensor 210. The second sensor 210 is a radar sensor. The third encoder 206 is assigned to a third sensor 212. The third sensor 212 is another sensor that is different from the first and the second sensor, for example an acceleration sensor. The first sensor 208 provides first sensor data to the first encoder 202 for compressing S2. The second sensor 210 provides second sensor data to the second encoder 204 for compressing S3. The third sensor 212 provides third sensor data to the third encoder 206 for compressing (equivalent to steps S2 and S3). The features of the first, the second, and the third sensor data are merged into a common feature embedding space 214 by a transformer 216.

The machine learning model 200 furthermore comprises a first pose regressor head 218, a second pose regressor head 220, and a third pose regressor head 222. Decoding S5 the merged features from the common feature embedding space for outputting a pose estimate 224 for the first sensor 208 is carried out by the first pose regressor head 218. Decoding S6 the merged features from the common feature embedding space for outputting a pose estimate 226 for the second sensor 210 is carried out by the second pose regressor head 220. Decoding (similar to S5 and S6) the merged features from the common feature embedding space for outputting a pose estimate 228 for the third sensor 212 is carried out by the third pose regressor head 222.

1-11. (canceled)

12. A method for training a machine learning model for processing multimodal data, the machine learning model including a first encoder, a second encoder, a transformer, a first pose regressor head, and a second pose regressor head, the method comprising the following steps:
providing first sensor data acquired by a first sensor and second sensor data acquired by a second sensor;
compressing the first sensor data by the first encoder into a feature dimension with features from the first sensor data;
compressing the second sensor data by the second encoder into a feature dimension with features from the second sensor data;
merging the features of the first sensor data and the features of the second sensor data into a common feature embedding space, by the transformer;
decoding the merged features from the common feature embedding space for outputting a pose estimate for the first sensor by the first pose regressor head;
decoding the merged features from the common feature embedding space for outputting a pose estimate for the second sensor by the second pose regressor head;
minimizing a loss function for optimizing the pose estimation for the first sensor and the pose estimation for the second sensor; and
providing the trained machine learning model for processing multimodal data.

13. The method according to claim 12, wherein: (i) the first encoder is assigned to the first sensor and includes a transformer-based encoder or a vision encoder or a radar encoder or a lidar encoder, and/or (ii) the second encoder is assigned to the second sensor and includes a transformer-based encoder or a vision encoder or a radar encoder or a lidar encoder.

14. The method according to claim 12, wherein the pose estimation for the first sensor and the pose estimation for the second sensor are carried out with respect to a global coordinate system or in relative terms between the first and second sensors.

15. The method according to claim 12, wherein the minimizing of the loss function for optimizing the pose estimation for the first sensor and the pose estimation for the second sensor includes comparing with a ground-truth value of a real pose of the first sensor and a real pose of the second sensor.

16. The method according to claim 12, wherein the pose estimation for the first sensor and/or the post estimation for the second sensor includes a rotation estimation and a translation estimation, wherein the rotation estimation includes solving a regression-by-classification problem.

17. The method according to claim 16, wherein the solving of the regression-by-classification problem includes: dividing a rotation space into a voxel grid and classifying which voxel optimally represents a rotation; and regressing an actual rotation as an offset from a voxel center to the rotation estimate.

18. The method according to claim 16, wherein: (i) the first sensor includes a lidar sensor and/or a radar sensor and/or an ultrasonic sensor and/or a camera sensor and/or an infrared sensor and/or an acceleration sensor and/or a global navigation satellite system (GNSS) sensor, and/or (ii) the second sensor includes a lidar sensor and/or a radar sensor and/or an ultrasonic sensor and/or a camera sensor and/or an infrared sensor and/or an acceleration sensor and/or a global navigation satellite system (GNSS) sensor.

19. The method according to claim 12, wherein the first sensor and the second sensor are arranged at different positions of a vehicle in order to detect the vehicle and/or a vehicle environment.

20. A non-transitory computer-readable data carrier on which are stored program code of a computer program for training a machine learning model for processing multimodal data, the machine learning model including a first encoder, a second encoder, a transformer, a first pose regressor head, and a second pose regressor head, the program code, when executed by a computer, causing the computer to perform the following steps:
providing first sensor data acquired by a first sensor and second sensor data acquired by a second sensor;
compressing the first sensor data by the first encoder into a feature dimension with features from the first sensor data;
compressing the second sensor data by the second encoder into a feature dimension with features from the second sensor data;
merging the features of the first sensor data and the features of the second sensor data into a common feature embedding space, by the transformer;
decoding the merged features from the common feature embedding space for outputting a pose estimate for the first sensor by the first pose regressor head;
decoding the merged features from the common feature embedding space for outputting a pose estimate for the second sensor by the second pose regressor head;
minimizing a loss function for optimizing the pose estimation for the first sensor and the pose estimation for the second sensor; and
providing the trained machine learning model for processing multimodal data.

21. A device configured to train a machine learning model for processing multimodal data, the machine learning model including a first encoder, a second encoder, a transformer, a first pose regressor head, and a second pose regressor head, the device comprising an evaluation and computing unit configured to perform the following steps:
providing first sensor data acquired by a first sensor and second sensor data acquired by a second sensor;
compressing the first sensor data by the first encoder into a feature dimension with features from the first sensor data;
compressing the second sensor data by the second encoder into a feature dimension with features from the second sensor data;
merging the features of the first sensor data and the features of the second sensor data into a common feature embedding space by the transformer;
decoding the merged features from the common feature embedding space for outputting a pose estimate for the first sensor by the first pose regressor head;
decoding the merged features from the common feature embedding space for outputting a pose estimate for the second sensor by the second pose regressor head;
minimizing a loss function for optimizing the pose estimation for the first sensor and the pose estimation for the second sensor; and
providing the trained machine learning model for processing multimodal data.
